(19) United States
(12) Patent Application Publication
(10) Pub. No.: US 2012/0056811 A1
(43) Pub. Date: Mar. 8, 2012

(54) Display device for vehicle

(75) Inventors: Takeshi Tottori, Obu-shi (JP); Kenichi Takenaka, Handa-shi (JP)

(73) Assignee: DENSO CORPORATION, Kariya-city (JP)

(21) Appl. No.: 13/199,281

(22) Filed: Aug. 24, 2011

(30) Foreign Application Priority Data
Sep. 2, 2010 (JP) 2010-197038

(51) Int. Cl. G06F 3/033

(52) U.S. Cl. 345/161

(57) ABSTRACT

In a vehicle display device equipped with a display on which a plurality of display zones is displayed, a user inputs through an operation lever a pointer moving request to move a pointer and a zone selection request to select another display zone as a selected display zone. An interface control part selects a reaction force map corresponding to the selected display zone after completion of the zone selection request from reaction force maps generated every display zone and stored in advance. Each reaction force map corresponds to each display zone and contains information of a reaction force corresponding to the position information of the button on the display zone. A reaction force supplying part supplies the reaction force to the operation lever on the basis of the selected reaction force map when the position of the pointer is overlapped with the button by the pointer moving request.

### CROSS-REFERENCE TO RELATED APPLICATION

This application is related to and claims priority from Japanese Patent Application No. 2010-197038 filed on Sep. 2, 2010, the contents of which are hereby incorporated by reference.

### BACKGROUND OF THE INVENTION

1. Field of the Invention

The present invention relates to display devices mounted on motor vehicles on which various types of images regarding various data items such as road information, vehicle conditions, warnings, etc. are displayed.

2. Description of the Related Art

There are various types of vehicle display devices mounted on motor vehicles equipped with a display on which a plurality of display zones (or windows) is displayed. For example, a Japanese patent laid open publication No. H06-195056 has disclosed a display device with a display on which a plurality of display zones is displayed. Various information data items are displayed in each of the display zones, such as map information, television broadcasting programs, vehicle information, etc.

Further, a Japanese patent laid open publication No. 2010-108255 has disclosed a vehicle operation system mounted to a motor vehicle equipped with a display device. A plurality of display zones is generated on a display of the display device. Various types of switches and buttons are displayed on each display zone in order for the vehicle driver as the user to operate a navigation ECU, etc. The vehicle operation system has an operation device with which the vehicle driver of the motor vehicle generates a pointer moving request to move the pointer displayed on the display, namely, displayed on the display zones, in order to select a switch. When the vehicle driver moves the pointer from one display zone to another on the display and selects the switch displayed on the selected display zone, in which the user can currently work, which is selected by moving the pointer into this display zone by the vehicle driver. Thus, the selected display zone is selected from a plurality of the display zones displayed on the display by moving the pointer.

Still further, a Japanese patent laid open publication No. 2010-146170 had disclosed a vehicle display device equipped with an input device mounted to a motor vehicle. The input device is equipped with a reaction force generation means. The reaction force generation means generates a reaction force against the operation of the input device used by the vehicle driver such as the user. The input device disclosed in the Japanese patent laid open publication No. 2010-146170 has a joystick part. When the pointer displayed on the display is moved by the pointer moving request generated by the joystick part and the moved pointer is overlapped with a button, the reaction force generation means generates a reaction force against the operation of the joystick part by the vehicle driver, and supplies the generated reaction force to the joystick part.

The input device disclosed in the Japanese patent laid open publication No. 2010-146170 generates a reaction force map for every setting window, where the setting window is a window (or a display zone) displayed on the display, into which the vehicle driver as the user can input various instructions and data items and select buttons. This reaction force map indicates the reaction force to be supplied to the joystick part on the basis of the position information of the button in the setting window. Specifically, an electric control unit (ECU) generates such a reaction force map for every setting window to be displayed on the display zone. This ECU receives the position information of the pointer displayed on the setting window transferred from a navigation ECU. The navigation ECU generates each display zone to be displayed on the display. When the setting window displayed on the display is switched, the ECU receives the position information of the button, transferred from the navigation ECU, displayed on the new setting window after completion of the switch of the setting window, and generates the reaction force map which corresponds to the setting window displayed on the display zone.

A combination of the structure of the joystick part in the input device disclosed in the Japanese patent laid open publication No. 2010-146170 with the structure of the display on which a plurality of display zones is displayed disclosed in the Japanese patent laid open publication No. 2010-108255 requires the ECU to receive the position information of the pointer displayed on the display zone and to generate the reaction force map on the basis of the received position information of the pointer every time the setting window displayed on the display zone is switched by selecting the button in a particular display zone.

Every time the currently-working setting window (or selected display zone) displayed on the display is switched, the reaction force generation means must wait to supply a correct reactive force to the input means until the ECU completely receives the position information of the button and generates the reaction force map. Accordingly, this causes a drawback of it being impossible to timely supply the correct reactive force against the user's operation to the joystick part due to the delay of generating the reaction force map when the pointer is overlapped with the button displayed on the selected display zone after completion of the switch of the selected display zone. When the reaction force to be supplied to the joystick part in the input device is interrupted, usability of the input device is deteriorated.

### SUMMARY OF THE INVENTION

An object of the present invention is to provide a vehicle display device with an input device of superior comfort and operability.

A present exemplary embodiment according to the present invention provides a vehicle display device having a display, an input means, a reaction force map storage means, a reaction force map selection means and a reaction force supplying means.

The vehicle display device is mounted to a motor vehicle. A plurality of display zones is formed on the display. Buttons are displayed on the display zones through which a user inputs operation instruction to control various types of operation regarding the motor vehicle. Through the input means the user inputs a pointer moving request and a zone selection request. The pointer moving request is an instruction to move a position of a pointer displayed on the display in order to select the buttons. The zone selection request is an instruction to select another display zone as a current display zone from the plurality of the display zones. The user selects the button displayed on the selected display zone when the user moves the pointer onto the selected display zone. The reaction force map storage means is configured to store a reaction force map which is generated per display zone in advance. The reaction force map determines a reaction force to be supplied to the operation means on the basis of the position information of the button on the selected display zone. The reaction force map selection means is configured to select the reaction force map from a plurality of the reaction force maps so that the selected reaction force map corresponds to the selected display zone when the selected display zone is switched by the zone selection request. The reaction force supplying means is configured to supply the reaction force to the input means on the basis of the selected reaction force map which corresponds to the selected display zone when on the basis of the pointer moving request, the pointer is overlapped with the button displayed on the selected display zone after completion of the selection of the display zone by the zone selection request.

The reaction force maps are stored in advance in the layers in the reaction force map generation means, for example, in the interface control part 34, where the reaction force is supplied to the input means and determined according to the position information of the button displayed on each display zone.

Accordingly, when the current display zone is switched with another display zone due to the zone selection request (namely, when the new display zone is selected by the zone selection request), it is sufficient for the reaction force map selection means to select the reaction map, which corresponds to the selected display zone selected due to the execution of the zone selection request, from the reaction force maps generated every display zone.

As described above, the reaction force supplying means supplies the reaction force to the input means on the basis of the reaction force map which corresponds to the selected display zone which is selected by the reaction force map selection means from the reaction force maps stored in advance when the selected display zone is switched, namely, when another display zone is newly selected as the new selected display zone. Accordingly, even if the selected display zone is switched due to the execution of the zone selection request, the reaction force supplying means starts to timely supply the correct reaction force to the input means such as a joystick without delay when the pointer is overlapped with the button displayed on the selected display zone switched by the zone selection request. This structure makes it possible for the vehicle display device to provide a superior comfortable operation to the user such as the vehicle driver.

In accordance with another exemplary embodiment, the vehicle display device further has an image generation means. The image generation means is configured to generate the buttons per the display zone. The buttons are generated on the respective display zone by the respectively corresponding image generation means. The reaction force supplying means receives the position information of the button displayed on the display zone transferred from the respectively corresponding image generation means, and stores the reaction force map which corresponds to the position information of each button every display zone in advance.

By the way, in a conventional structure to generate a reaction force map every time the zone selection request is generated, it is necessary for the reaction force map storage means to generate the position information of the button every time another display zone as a new display zone is selected. The above conventional structure often delays the time to start supplying the reaction force to the input means by the period of time necessary to obtain the position information of the button from the image generation means.

On the other hand, the reaction force map generation means in the vehicle display device according to the present exemplary embodiment can receive the position information of the button in each display zone from the different image generation means and stores the reaction force maps of the display zones corresponding to the position information of the button in advance. Accordingly, it is possible for the reaction force supplying means to start supplying the correct reaction force to the input means without delay.

As described above, the vehicle display device can provide comfortable operation to the user by timely supplying the correct reaction force to the input means even if the time delay is caused when the position information of the button is obtained from the different image generation means.

In the vehicle display device as another exemplary embodiment, the input means inputs the pointer moving request to move the pointer to a boundary part between the selected display zone and the other display zone which is adjacent to the selected display zone. The input means then inputs the zone selection request in order to select another display zone in order to use another display zone as the current display zone.

In the vehicle display device according to the present exemplary embodiment, the user inputs the zone selection request through the input means. This zone selection request switches the current display zone to another display zone. That is, the zone selection request is generated by moving the pointer to the boundary part between the current display zone and the display zone which is adjacent to the current display zone. Accordingly, the zone selection request is generated during the execution of the pointer moving request to move the pointer. If the supply of the reaction force to the input means is interrupted during the continuation of the operation to the input means by the user, there is a possibility for the vehicle display device to provide remarkable uncomfortable operation to the user.

On the other hand, the reaction force supplying means in the vehicle display device according to the present exemplary embodiment can start timely supplying the correct reaction force to the input means on the basis of the reaction force map corresponding to the current display zone selected by the reaction force map selection means when the selected display zone is switched due to the execution of the zone selection request. Accordingly, it is possible to completely avoid the interruption of the supply of the reaction force to the input means. The vehicle display device according to the present exemplary embodiment can provide the superior comfort of operation to the user even if the structure of the vehicle display device tends to cause uncomfortable operation of the input means.

In the vehicle display device according to the other exemplary embodiment, each of the reaction force maps has the same resolution of the position information of each button.

According to the present exemplary embodiment, the resolution of the position information of a button, to be displayed, in each of the reaction force map has the same value regardless of the size of the display zone corresponding to the reaction force map. Accordingly, when the button in each display zone has the same size, it is possible for the user to receive the same reaction force through the input means when the pointer is overlapped with the button even if each display zone has a different size. Even if the vehicle display device has a structure to switch the reaction force map in addition to the selected display zone, it is possible to supply the same reaction force to the input means when each button has the same resolution. Accordingly, the vehicle display device according to the present exemplary embodiment can supply the superior and comfortable operation to the user such as the vehicle driver.

In the vehicle display device according to another exemplary embodiment, the input means is a joystick equipped with an operation lever (of a joystick). When the user deflects the operation lever of the joystick, the reaction force supplying means supplies a reaction force to the operation lever in a direction which is opposite to the direction to which the user deflects the operation lever of the joystick.

The reaction force supplying means supplies the reaction force to the operation of the operation lever in a direction which is opposite to the direction to which the user deflects the operation lever of the joystick. This makes it possible to supply the reaction force to the user through the operation lever with certainly. Thus, the vehicle display device equipped with the joystick as the input means can timely supply the superior comfortable operation to the user because the device can supply the reaction force to the operation lever of the joystick continuously.

### BRIEF DESCRIPTION OF THE DRAWINGS

A preferred, non-limiting embodiment of the present invention will be described by way of example with reference to the accompanying drawings, in which:

FIG. 1 is a view showing a schematic configuration of a vehicle display device according to an exemplary embodiment of the present invention;

FIG. 2A is a view showing a coordinate system of a display position which is determined relative to the display in order to explain the operation to an operation lever and a pointer by a user, in which the operation lever and the pointer are linked together;

FIG. 2B is a view showing a coordinate system of an operation position which is determined along the direction to which the operation lever is deflected by the user;

FIG. 3 is a view showing display zones displayed on a display generated by the vehicle display device according to the exemplary embodiment of the present invention on which a navigation image is displayed as a main image, and an information image is displayed as a complementary image;

FIG. 4 is a view showing display zones displayed on the display generated by the vehicle display device according to the exemplary embodiment of the present invention on which an audio image is displayed as a main image and an information image is displayed as a complementary image;

FIG. 5A is a view showing a schematic structure of a reaction force map used by an operation device in the vehicle display device according to the exemplary embodiment of the present invention;

FIG. 5B is a view showing a structure of layers capable of storing reaction force maps in an interface control unit in the operation device;

FIG. 6 is a view showing the change of the reaction force which is supplied to the operation lever when the user operates the operation lever in order to overlap the pointer with the buttons displayed on the display zones displayed on the display;

FIG. 7 is a view showing a flow chart of a control flow executed by an interface control part when the main image displayed on the main display zone is changed by the operation device;

FIG. 8 is a flow chart showing a control flow executed by the interface control part when a complementary image displayed on a complementary display zone is changed by the operation device;

FIG. 9 is a flow chart showing a control flow executed by the main control part in the control circuit when receiving a zone selection request for selecting a display zone as a selected display zone from the main display zone and the complementary display zone; and

FIG. 10 is a flow chart showing a control flow executed by the interface control part in order to select a reaction force map as a selected reaction force map from the main reaction force map and the complementary reaction force map.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

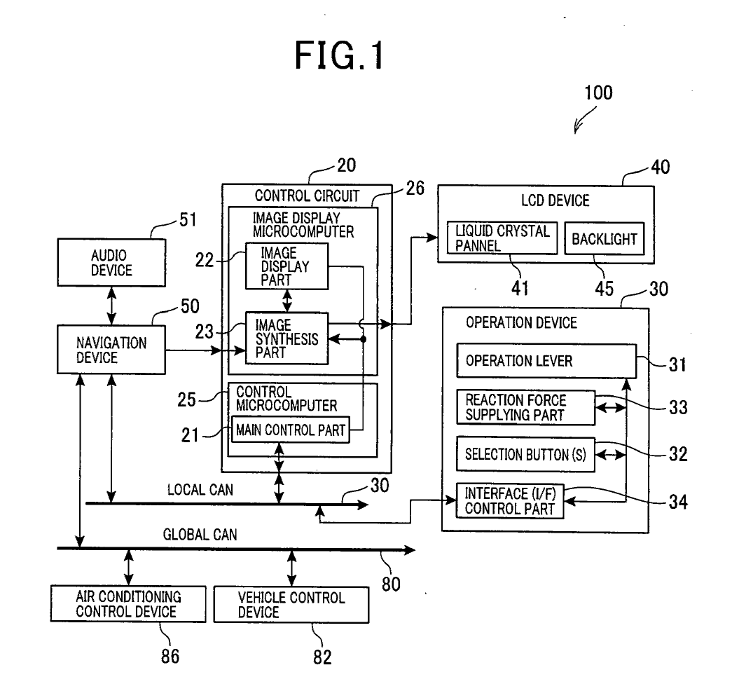

A description will be given of the vehicle display device 100 according to an exemplary embodiment of the present invention with reference to FIG. 1 to FIG. 10.

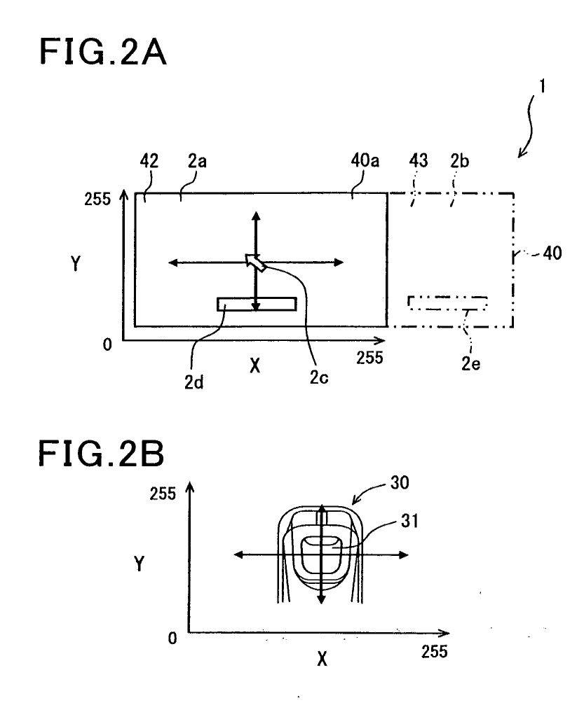

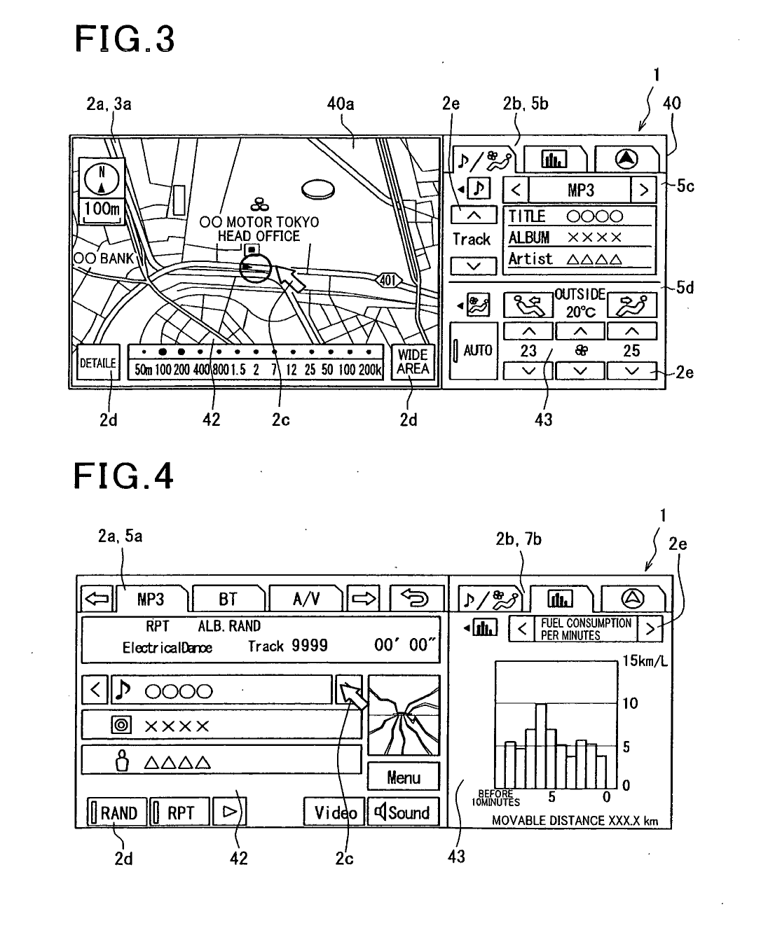

FIG. 1 is a view showing a schematic configuration of the vehicle display device 100 according to the exemplary embodiment of the present invention. FIG. 2A is a view showing a coordinate system of a display position determined along the display in order to explain user's operation of the operation lever 31 and a pointer. On the display zone displayed on the window the operation lever 31 and the pointer are linked together. FIG. 2B is a view showing a coordinate system of an operation position which is determined along the direction to which the operation lever 31 is deflected by the user. FIG. 3 is a view showing display zones displayed on the display generated by the vehicle display device 100 on which a navigation image is displayed as a main image and an information image is displayed as a complementary image. FIG. 4 is a view showing display zones displayed on the display generated by the vehicle display device 100 on which an audio image is displayed as a main image and an information image is displayed as a complementary image.

As shown in FIG. 1, the vehicle display device 100 is mounted to a motor vehicle. The vehicle display device 100 is equipped with an operation device 30, a navigation device 50, a control circuit 20 and a liquid crystal display device 40.

The vehicle display device 100 displays various displayed images such as a displayed image 1 displayed in the display shown in FIG. 3 and FIG. 4 on the display 40a on the liquid crystal display device (LCD) 40. As shown in FIG. 3 and FIG. 4, the displayed image 1 is composed of the main image 2a and the complementary image 2b displayed on a main display zone 42 and a complementary display zone 43, respectively. The main display zone 42 and the complementary display zone 43 are formed on the display 40a of the LCD 40. The main image 2a and the complementary image 2b are selected from a plurality of images, and displayed in parallel on the main display zone 42 and the complementary display zone 43, respectively.

A description will now be given of a global controller area network 80 (a global CAN 80) and a local a global controller area network 81 (a local CAN 81) with reference to FIG. 1.

The global CAN 80 and the local CAN 81 are on-vehicle network systems through which information is transferred between devices which are equipped with an on-vehicle device on the basis of a predetermined protocol. Various types of devices are connected to the global CAN 80 and the local CAN 81 through a bus composed of a pair of communication lines.

The navigation device 50, an air conditioning control device 86, a vehicle control device 82 and an engine control devices (not shown), etc. are connected to the global CAN 80. The air conditioning control device 86 controls an air conditioning of the motor vehicle. The vehicle control device 82 executes the total control of the motor vehicle. The engine control device (not shown) controls the operation of the internal combustion engine mounted to the motor vehicle. For example, the air conditioning control device 86 outputs vehicle information such as a set temperature, a supplying volume and a direction of air flow by the air conditioning device to the global CAN 80. The vehicle control device 82 outputs vehicle information such as fuel consumption of the motor vehicle to the global CAN 80, for example.

The operation device 30, the navigation device 50 and the control circuit 20 are connected to the local CAN 81.

As shown in FIG. 1, FIG. 2A and FIG. 2B, the vehicle driver of a motor vehicle as the user operates the operation device 30 which is placed in a center console of the motor vehicle. The operation device 30 generates a reaction force against the user's operation. The generated reaction force makes it possible for the user to obtain intuitive operation. The operation device 30 inputs various types of requests generated by the user such as to move a pointer, to select one or more display images and to switch a current display zone.

The pointer moving request is the request to move the position of the pointer 2c displayed on the display 40a in order to select button 2d or 2e regarding the motor vehicle. The user is invited to select one of the buttons 2d and 2e in order to input the vehicle operation.

The zone selection request is a request to select one or more display images from a plurality of images so as to display the selected display images on a main display zone 42 and a complementary display zone 43.

The zone selection request is a request to select a current display zone from the main display zone 42 and the complementary display zone 43 by moving the pointer 2c displayed on the display. It is possible for the user to select the button 2d or 2e through the pointer 2c.

The operation device 30 has the operation lever 31, the selection button 32, the interface control part 34, and the reaction force supplying part 33.

The operation lever 31 is a pointing device such as a joystick device to operate the pointer 2c displayed on the display 40a of the liquid crystal display (LCD) device 40. That is, the user uses the joystick device as the operation lever 31 in all directions in order to move or shift the pointer 2c on the plane of the display.

When the user deflects, namely, moves the operation lever 31 in X-Y directions along the movable direction of the operation lever 31, the position of the pointer 2c displayed on the display 40a is moved in accordance with the deflection direction of the operation lever 31 in the X-Y direction on the display 40a.

When the user moves the pointer 2c and overlaps the pointer 2c with the position of each of the buttons 2d and 2e, it is possible for the user to select the button 2d or 2e. In particular, the X direction indicates the lateral direction in the longitudinal direction of the display 40a, and the Y direction indicates the vertical direction of the display 40a.

Because the selection button 32 is displayed near the operation lever 31, the user easily pushes the selection button 32. When the vehicle driver pushes the selection button 32 after the user such as the vehicle driver overlaps the pointer 2c with the button 2d in order to allow the selection button 32 to be pushed, each of the on-vehicle devices can execute the process corresponding to the button 2d.

The interface control part 34 is comprised of a communication interface unit, etc. which is capable of communicating with a microcomputer and the local CAN 81. The microcomputer executes various types of arithmetic operations. The interface control part 34 is connected to the operation lever 34, the selection button 32, and the reaction force supplying part 33. When receiving a detection signal which is generated when the user deflects the operation lever 31, the interface control part 34 instructs the reaction force supplying part 33 to generate a reaction force against the deflection angle of the operation lever 31. The interface control part 34 outputs the information regarding the deflection position (or deflection angle) of the operation lever 31 to the local CAN 81. Further, the interface control part 34 outputs the operation information to the local CAN 81, where the operation information indicates the operation to push the selection button 32. The control circuit 20 and the navigation device 50 receive the operation information on the local CAN 81.

The reaction force supplying part 33 supplies the reaction force against the user's operation to the operation lever 31 when the pointer 2c is overlapped with the button 2d or 2e only, which is executed by the user. The reaction force supplying part 33 is equipped with an actuator capable of supplying such a reaction force in each of X direction and Y direction. The interface control part 34 controls the operation of the reaction force supplying part 33 having the above structure. This makes it possible for the reaction force supplying part 33 to generate and supply the reaction force to the operation lever 31, where the reaction force is the force supplied against the deflection angle in X and Y directions of the operation lever 31 generated by the user.

The navigation device 50 is connected to the global CAN 80, the local CAN 81, the audio device 51 and the vehicle display device 100, etc. The navigation device 50 receives vehicle information transferred from the air conditioning control device 86 and the vehicle control device 82, etc. through the global CAN 80. The navigation device 50 outputs the obtained vehicle information to the local CAN 81. Further, the navigation device 50 receives the operation information transferred from the operation device 30 through the local CAN 81. Still further, the navigation device 50 is equipped with a global positioning system (GPS) receiver and an electronic compass, etc. Such a GPS detects the current position of a motor vehicle and an electronic compass detects an azimuth of the motor vehicle.

The audio device 51 is one of the on-vehicle devices. The audio device 51 playbacks content data such as music data and images stored in storage devices such as optical discs and hard disk drives, flash memories, etc. The optical disks include a compact disk (CD, Registered trademark) and a digital video disk (DVD, Registered trademark). The audio device 51 outputs to the navigation device 50 the playback information such as the track title (or album name) of the music which is currently being played back and the content of the music. The navigation device 50 receives such information and outputs the received information to the local CAN 81. The music information includes the name of music, the name of artists (performing musicians), the name of an album and the image of then album, etc. The playback information includes the name of music, the playback and stop state of image, the elapsed period of time in playback, the track number, etc.

The navigation device 50 generates the navigation image 3a in order to assist the vehicle driver to operate the driving of the vehicle and direct the motor vehicle to the target destination on the basis of the vehicle information, the detection information transferred from the GPS receiver and the electronic compass, etc. obtained through the global CAN 80. Further, the navigation device 50 generates audio image 5a (see FIG. 4) in addition to the navigation image 3a (see FIG. 3). Each of the images 3a and 5a will be explained later in detail.

The navigation device 50 is connected to the control circuit 20 through communication lines. For example, the navigation device 50 selects one of images 3a and 5a (see FIG. 3 and FIG. 4) generated on the basis of the output protocol of image such as gigabit video interface (GVIF), Registered trademark) and outputs the selected image signals to the control circuit 20 sequentially.

The control circuit 20 is equipped with a control microcomputer 25 and an image display microcomputer 26. The control microcomputer 25 is comprised of a central processing unit which executes various types of arithmetic processes, a flash memory which stores programs of the above arithmetic processes, and a random access memory (RAM) which is a working area used during the arithmetic processes. The control microcomputer 25 is connected to the communication interface which transfers data to the local CAN 81.

The image display microcomputer 26 is comprised of a central processing unit to execute the image processing, a read only memory (ROM) or a flash memory to store the image data of the programs and various image data, and a random access memory (RAM) which is used as a working area during the execution of the arithmetic operation.

The image display microcomputer 26 is connected to an image output interface (not shown) through which the image display microcomputer 26 outputs image signals of the displayed image 1 to the liquid crystal display device 40.

The control circuit 20 having the above structure is equipped with a main control part 21, an image display part 22 and an image synthesis part 23.

The main control part 21 is a functional block of the control microcomputer 25. The control microcomputer 25 executes a predetermined program in order to execute the function of the main control part 21. The main control part 21 determines the image as the main image 2a and the complementary image 2b displayed on the displayed image 1 on the basis of the zone selection request which is contained in the operation information transferred through the local CAN 81. The main control part 21 instructs the image synthesis part 23 to generate the displayed image 1. Further, the main control part 21 outputs, to the image display part 22, the information to be used for generating the complementary image 2b such as the vehicle information, the music information, the playback state information, the operation information etc.

The image display part 22 and the image synthesis part 23 are functional blocks of the image display microcomputer 26. The image display microcomputer 26 executes a predetermined program so as to execute the function of the image display part 22 and the image display microcomputer 26.

The image synthesis part 23 receives, as the main image 2a, one of the images 3a, 5a (see FIG. 3 and FIG. 4) which are generated by the navigation device 50 mounted to the motor vehicle. The main image 2a, received by the image synthesis part 23, has a less number of pixels when compared with that of the displayed image 1.

The image display part 22 generates the number of pixels of the main image 2a received by the image synthesis part 23 and interpolation image 2b. The interpolation image 2b interpolates a difference in pixels between the main image 2a and the displayed image 1. In addition, the image display part 22 generates the pointer 2c and the button 2e and overlaps them together on the complementary image 2b. For example, the complementary image 2b corresponds to the information image 5b, the fuel consumption information image 7b, etc., where the information image 5b shows the information of the audio device and the air conditioning device (see FIG. 3) and the fuel consumption information image 7b shows the information of the fuel consumption of the motor vehicle (see FIG. 4). The image display part 22 outputs the complementary image 2b to the image synthesis part 23.

The image synthesis part 23 synthesizes the main image 2a and the complementary image 2b, where the main image 2a is generated on the basis of the image signals transferred from the navigation device 50, and the complementary image 2b is generated by the image display part 22. The image synthesis part 23 generates the displayed image 1 in which the main image 2a and the complementary image 2b are displayed and arranged in parallel. The control device 20 outputs the image signals sequentially to the LCD device 40 on the basis of the output protocol of Low Voltage Differential Signaling (LVDS), etc.

The LCD device 40 connected to the control device 20 is a display unit mounted on the central part of the instrument panel of the compartment of the motor vehicle. The displayed image 1 is displayed in the display 40a of a wide screen type on the LCD device 40 in order to provide various types of information to the vehicle driver.

In the display 40a, the main image 2a obtained by the image synthesis part 23 is displayed in the main display zone 42 and the complementary image 2b generated by the image synthesis part 23 is displayed in the complementary display zone 43.

The LCD device 40 has a back light 45 which supplies light to a LCD panel 41 from the back side of the LCD panel 41. Such a backlight is a form of illumination used in liquid crystal displays (LCDs). As LCDs do not produce light themselves, unlike for example cathode ray tube (CRT) displays, they need illumination, namely, ambient light or a special light source, to produce a visible image. A backlight illuminates the LCD from the side or back of the display panel, and light from the backlight penetrates the liquid crystal panel 41.

The display 40a is composed of 1280 display pixels in the lateral direction and 480 display pixels in the vertical direction which are regularly arranged. The main display zone 42 is composed of rows and columns, and each row has 800 dots along a lateral direction and each column has 480 dots along in a vertical direction. On the other hand, the complementary display zone 43 is composed of rows and columns, and each row has 480 dots along a lateral direction and each column has 480 dots along in a vertical direction.

The total number of pixels in the main display zone 42 corresponds to the number of pixels of the image generated by the navigation device 50. The navigation device 50 can generate image of a less number of pixels when compared with the number of pixels of the display 40a. The image display part 22 generates the complementary image 2b by using pixels which corresponds to the difference between the pixel number of the display 40a and the pixel number of the display image on the main display zone 42.

A description will now be given of the detailed operation of the display device 100 for a motor vehicle to move the display position of the pointer 2c on the display 40a on the basis of the user's input to the operation lever 31.

The interface control part 34 in the operation device 30 detects the deflection angle of the operation lever 31 which is deflected by the user. The interface control part 34 then converts the detected deflection angle data to data in a operation position coordinate system along X and Y directions (see FIG. 2B). In the exemplary embodiment, the interface control part 34 executes the above data conversion with a resolution of 8 bits in each of X and Y directions.

The interface control part 34 outputs, to the local CAN 81 as operation information, the coordinate data within a range of 0 to 255 in X and Y directions which show the deflection position of the operation lever 31.

The interface control part 34 stores the reaction force map in a memory, which is used to supply the reaction force to the operation lever 31. In the reaction force map has a correspondence between the strength of a reaction force and a coordinate data in one to one correspondence.

The data items which determine the reaction force to be supplied to the operation lever 31 are determined on the basis of the position information of each of the buttons 2d and 2e obtained from the navigation device 50 and the control circuit 20, namely, the coordinate data items of the buttons 2d and 2e in a display position coordinate system. This display position coordinate system will be explained later in detail.

When receiving the information regarding the user's operation of the operation lever 31, the interface control part 34 detects the deflection position of the operation lever 31 and obtains, namely, calculates the coordinate data in the operation position coordinate system in X and Y directions. The interface control part 34 refers to the reaction force map on the basis of the coordinate data and reads out the value which indicates the strength of the reaction force corresponding to the coordinate data. The interface control part 34 controls the reaction force supplying part 33 on the basis of the obtained value which indicates the strength of the reaction force. The reaction force supplying part 33 applies the controlled reaction force to the operation lever 31.

When the main display zone 42 is selected, the navigation device 50 determines the display position of the pointer 2c displayed on the main display zone 42 on the basis of the coordinate data in the display position coordinate system along X and Y directions of the display 40a (see FIG. 2A).

The coordinate data of the pointer 2c on the display position coordinate system corresponds to the coordinate data in the operation position coordinate system within a range of 0 to 255 in each of X and Y directions at which the deflection position of the operation lever 31 is detected.

The navigation device 50 obtains the coordinate data in X and Y directions which indicate the deflection position of the operation lever 31 as the operation information through the local CAN 81. The navigation device 50 uses the coordinate data, namely within a range of 0 to 255, on the operation position coordinate system and thereby determines the display position of the pointer 2c on the main display zone 42. Further, every time the main image 2a displayed on the main display zone 42 is changed due to the zone selection request, the navigation device 50 outputs to the local CAN 81 the position information of the button 2d contained in the main image 2a. The interface control part 34 receives the position information of the button 2d which is output as the coordinate data using the display position coordinate system.

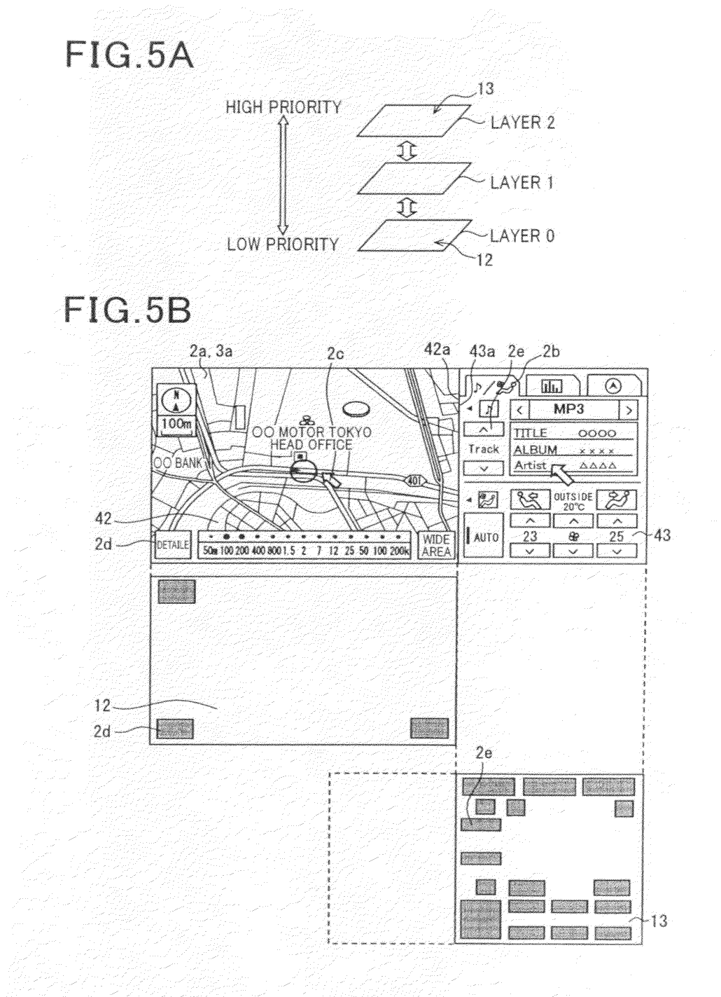

FIG. 5A is a view showing a schematic structure of a reaction force map used by the operation device 30 in the vehicle display device 100. FIG. 5B is a view showing a structure of layers which have the reaction force map in an interface control unit in the operation device 30. The interface control part 34 generates the main reaction force map 12 (see FIG. 5A and FIG. 5B) on the basis of the received position information of the button 2d.

On the other hand, when the complementary display zone 43 is selected, the main control part 21 determines the display position of the pointer 2c displayed on the complementary display zone 43 on the basis of the coordinate data in the display position coordinate system along X and Y directions of the display 40a (see FIG. 2A).

The coordinate data of the pointer 2c displayed on the display position coordinate system corresponds to the coordinate data in the operation position coordinate system within a range of 102 to 255 in X direction and a range of 0 to 255 in Y direction at which the deflection position of the operation lever 31 is detected.

The main control part 21 obtains the coordinate data, which indicate the coordinate data in X and Y directions which indicate the deflection position of the operation lever 31 as the operation information through the local CAN 81.

The main control part 21 uses the coordinate data in the operation position coordinate system as the coordinate data of the pointer 2c in the display position coordinate system, determines the display position of the pointer 2c on the main display zone 42, and outputs an instruction to the image display part 22.

Further, every time the complementary image 2b displayed on the complementary display zone 43 is changed due to the zone selection request, the main control part 21 outputs to the local CAN 81 the position information of the button 2e contained in the complementary image 2b in the complementary display zone 43. The interface control part 34 receives the position information of the button 2e through the local CAN 81 as the coordinate data using the display position coordinate system. The interface control part 34 generates the complementary reaction force map 13 (see FIG. 5A and FIG. 5B) on the basis of the received coordinate data.

Next, a description will now be given of the displayed image 1 displayed on the display 40a in detail with reference to FIG. 1, FIG. 3 and FIG. 4. In particular, each of FIG. 3 and FIG. 4 shows an example of the displayed image 1 composed of a plurality of images.

The navigation image 3a as the main image 2a shown in FIG. 3 shows a map image which indicates the current position of the motor vehicle. The navigation image 3a shows the current position, the moving direction, a necessary period of time for the motor vehicle to reach a target destination, etc. The pointer 2c and the button 2d are displayed on the navigation image 3a.

When the user moves the pointer 2c and overlaps it with the button 2d, and the user then pushes the selection button 32 in the operation device 30, the map image is expanded or reduced on the navigation image 3a.

The information image 5b as the complementary image 2b is generated by the image display part 22 on the basis of the music information, the playback state information, and the vehicle information which are obtained through the local CAN 81. The information image 5b is composed of the audio information image 5c and the air conditioning information 5d as shown in FIG. 3. The audio information image 5c and the air conditioning information 5d are displayed in parallel along a vertical direction of the display 40a in the complementary display zone 43.

The audio information image 5c shows the track title and the album name of the music currently playback by the audio device 51. In addition, the audio information image 5c has a button 2e. The vehicle driver can selects a number of music to playback and adjust the volume thereof. When the user overlaps the button 2e with the pointer 2c and pushes the selection button 32, the operation device 30 transfers the information to the audio device 51. When receiving the information, the audio device 51 adjusts the volume of the music and selects the music on the basis of the information transferred from the operation device 30.

The air conditioning information image 5d shows information on the current state of the air conditioner such as the volume of air, the direction of air flow, set temperature, etc. In addition, the air conditioning information image 5d has the button 2e in order to change the set temperature and the volume of air flow of the air conditioning. When the user overlaps the pointer 2c with the button 2e and pushes the selection button 32 in the operation device 30, the operation device 30 transfers the information. When receiving the information transferred from the operation device 30, the air conditioning device 86 changes the set temperature and the volume of the air flow on the basis of the received information.

The navigation device 50 generates the audio image 5a as the main image 2a shown in FIG. 4 on the basis of the music information obtained from the audio device 51. The audio image 5a is an image to inform the track title name, the album name, etc., a program of music which is currently playback. In addition, the audio image 5a has the button 2d. The user adjusts the volume of the music and selects a program of music to be played back through the button 2d on the audio image 5a. When the user overlaps the pointer 2c with the button 2d and then pushes the selection button 32, the operation device 30 transfers the information. When receiving the information transferred from the operation device 30, the audio device 51 adjusts the volume of the music and selects the music to be played back.

The image display part 22 generates the fuel consumption display image 7b as the complementary image 2d shown in FIG. 4 on the basis of the vehicle information, specifically, the fuel consumption information of the motor vehicle, obtained from the vehicle control device 82. For example, the fuel consumption display image 7b is a graph showing a series of the fuel consumption of the motor vehicle every minute. The fuel consumption display image 7b has the button 2e. The user changes the complementary image 2b to be displayed on the complementary display zone 43. When the user overlaps the pointer 2c with the button 2e and pushes the selection button 32, the operation device 30 transfers the information. When receiving the information transferred from the operation device 30, the vehicle display device 100 changes the image displayed on the complementary display zone 43.

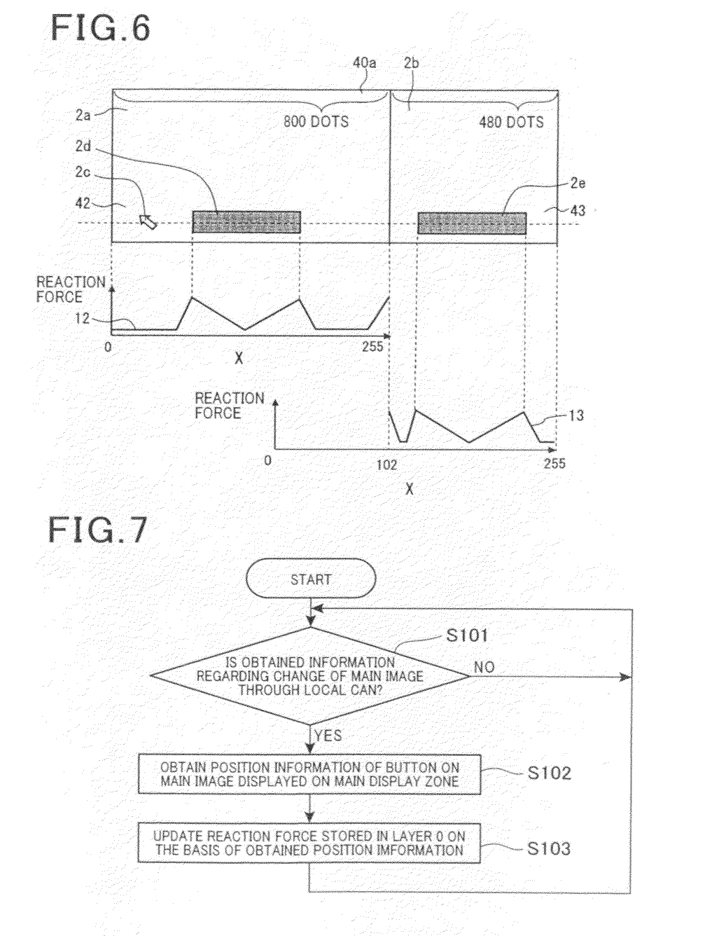

Next, a description will now be given of the vehicle display device 100 with reference to FIG. 1, FIG. 2, FIG. 5A, FIG. 5B and FIG. 6.

The interface control part 34 has a plurality of layers (see FIG. 5A) in order to store the reaction force maps which correspond to display zones, respectively. In the exemplary embodiment, the interface control part 34 has the three layers, layer 0, layer 1 and layer 2. The three layers composed of the layer 0, layer 1 and layer 2 have a priority order. In addition to this, each layer has two states, effectiveness (namely, selected) and ineffectiveness (namely, deselected) which are switched. The interface control part 34 selects, as the active reaction force map, each reaction force map stored in the layer having the highest priority from the layers which are of effectiveness. The layer 2 is the highest priority, the layer 1 has the middle priority and the layer 0 is the lowest priority.

The main reaction force map 12 (see FIG. 5B) is made on the basis of the position information of the button 2d on the main display zone 42 transferred from the navigation device 50. This main reaction force map 12 is stored in advance in the layer 0 obtained from the navigation device 50. The main reaction force map 12 is updated on the basis of the position information of the button 2d, namely, the coordinate data of the button 2d output from the navigation device 50 every time the main image 2a displayed on the main display zone 42 is changed by the user's zone selection request.

The layer 1 stores the reaction force map which is made on the basis of the button contained in the recognition image which is overlapped with and displayed on the main image 2a. For example, the recognition image overlapped with the main image 2a is an image to show the message “Close the map display ?” when the user deselects the navigation image 3a and selects the other main image 2a. The recognition image contains the button such as “YES” and “NO”. The interface control part 34 receives the position information of the button from the navigation device 50. The interface control part 34 stores the reaction force map into the layer 1 which is used when the recognition image is displayed on the main display zone 42.

The complementary reaction force map 13 (see FIG. 5B) is made on the basis of the position information of the button 2e on the complementary display zone 43 transferred from the control device 20. This complementary reaction force map 13 is stored in advance in the layer 2 obtained from the control device 20. The complementary reaction force map 13 is updated on the basis of the position information of the button 2e namely, the coordinate data of the button 2e output from the control device 20 every time the complementary image 2b displayed on the complementary display zone 43 is changed by the user's zone selection request.

In the exemplary embodiment, because the pointer 2c is displayed at the boundary parts 42a and 43a of the main display zone 42 and the complementary display zone 43, it is possible to select a current display zone from the main display zone 42 and the complementary display zone 43. According to selecting the current display zone from the main display zone 42 and the complementary display zone 43, the interface control part 34 changes the effectiveness and ineffectiveness of each layer, and selects, as the active reaction force map, the reaction force map corresponding to the active display zone.

Next, a description will be given of the reaction force against the user's operation supplied from the reaction force supplying part 33 to the operation lever 31 when the pointer 2c is overlapped with each of the buttons 2d, 2e.

FIG. 6 is a view showing the change of the reaction force which is supplied to the operation lever 31 when the user operates the operation lever 31 in the operation device 30 in order to overlap the pointer with the button displayed on the display.

When the user moves the pointer 2c near to each of the buttons 2d and 2e, the reaction force against its operation is gradually increased (see FIG. 6). The reaction force against its operation has the maximum value when the pointer 2c reaches the outline part of each of the buttons 2d and 2e, and gradually decreased when the pointer 2c reaches the central part of each of the buttons 2d and 2e. The user such as the vehicle driver recognizes, through his sense of touch, the outline of each of the buttons 2d and 2e by the reaction force against its operation. When the pointer 2c is overlapped with each of the buttons 2d, 2e, the force to move the pointer 2c to the central part of each of the buttons 2d and 2e is given to the vehicle driver as the user.

The exemplary embodiment has the structure so that the reaction force against the operation lever 31 has the same force when the user overlaps the pointer 2c with each of the buttons 2d and 2e having the same size, namely, the same number of display pixels. That is, the exemplary embodiment has the structure in which the resolution of the position information of each of the buttons 2d and 2e has the same.

In more detail, the display zones with 800 horizontal pixels are arranged in the X direction on the main display zone 42. In the main reaction force map 12 corresponding to the main display zone 42, the coordinate within a range of 0 to 255 in the X direction is assigned to the main display zone 42. That is, the number of display pixels which are assigned to one coordinate point in the X direction in the main reaction force map 12 is approximately 3.1 (=800 dots/255 coordinate points).

On the other hand, the display zones with 480 pixels are arranged in the X direction on the complementary display zone 43. In the complementary reaction force map 13 corresponding to the complementary display zone 43, the coordinate points within a range of 102 to 255 are assigned in the X direction to the main display zone 42. That is, the number of display pixels which are assigned to the coordinate point in the X direction in the main reaction force map 12 is approximately 3.1 (=480 dots/153 coordinate points).

Having the above structure of the main display zone 42 and the complementary display zone 43 makes it possible for the distance of the pointer 2c moved by the user on the display 40a to be constant regardless of the size of the display zone displaying the pointer 2c. Accordingly, as shown in FIG. 6, the magnitude of the reaction force supplied to the operation lever 31 has the same value when the user overlaps the pointer 2c with each of the buttons 2d and 2e

Further, when the user moves the pointer 2c near to the boundary part 42a or 43a, the reaction force against the operation by the user is gradually increased (see FIG. 6). As described above, because a strong reaction force is supplied to the operation lever 31 when the pointer 2c approaches the boundary parts 42a and 43a, the user such as the vehicle driver can recognize the presence of the wall at the boundary parts 42a and 43a through his sense of touch.

A description will be given of the process of updating the main reaction force map 12 stored in the layer 1 of the interface control part 34 when the main image 2a displayed on the main display zone 42 is changed by the operation device 30 having the above structure with reference to FIG. 7.

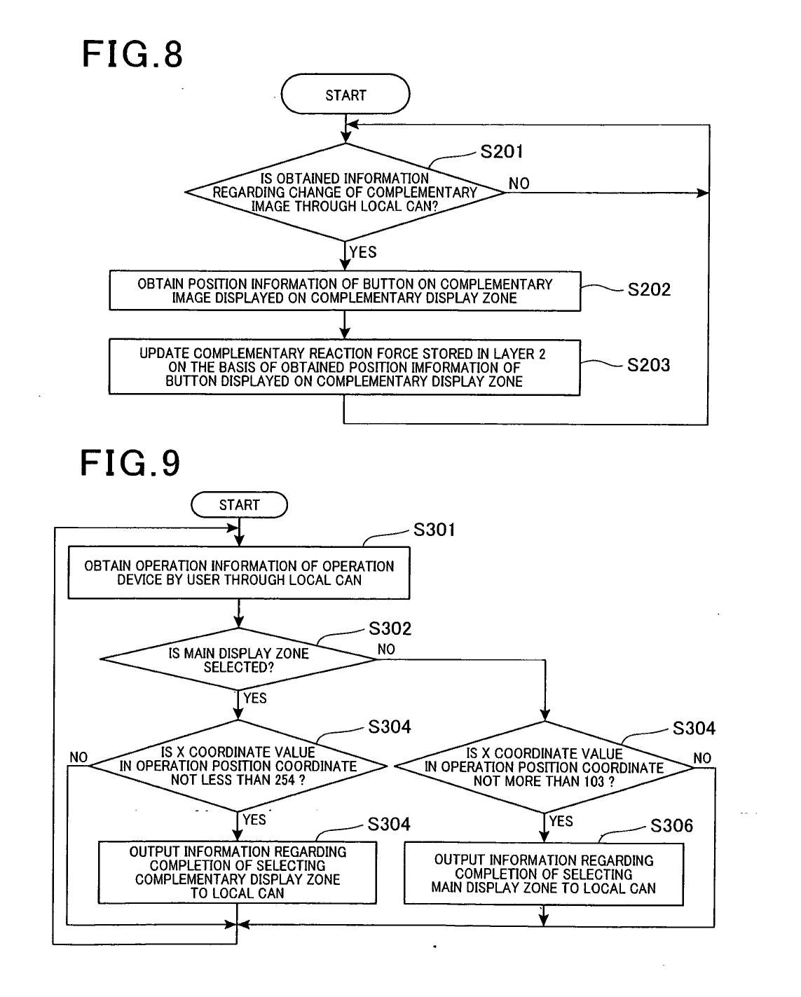

FIG. 7 is a view showing a flow chart of a control flow executed by the interface control part 34 when the main image displayed on the main display zone 42 is changed by the operation device 30. FIG. 8 is a view showing a flow chart of a control flow executed by the interface control part 34 when a complementary image displayed on a complementary display zone 43 is changed by the operation device.

The interface control part 34 executes the process in the flow chart shown in FIG. 7 and the process shown in FIG. 8 (which will be explained later) when the user such as the vehicle driver turns on the accessory (ACC) power source of the motor vehicle. The interface control part 34 repeatedly executes the process until the user turns off the ACC power source.

When the operation device 30 receives the request to change the main image 2a displayed on the main display zone 42, the control circuit 20 outputs the information that the main image 2a has been changed to the local CAN 81.

In step S101 shown in FIG. 7, the interface control part 34 detects whether or not the control circuit 20 receives the information regarding the change of the main image 2a through the local CAN 81. When the detection result in step S101 indicates positive (affirmation), namely, the control circuit 20 receives the information regarding the change of the main image 2a through the local CAN 81 (“YES” in step S101), the operation flow goes to step S102.

On the other hand, when the detection result in step S101 indicates negative, namely, the control circuit 20 does not receive the information regarding the change of the main image 2a through the local CAN 81 (“NO” in step S101), the operation flow returns to step S101. The detection in step S101 is executed again.

In step S102, the control circuit 20 receives the position information of the button 2d to be displayed on the main display zone 42 after the change of the main image 2a, namely, the coordinate data of the button 2d transferred from the navigation device 50 through the local CAN 81. The operation flow goes to step S103. It is possible for the navigation device 50 to output the position information of the button 2d when receiving the request signal transferred from the interface control part 34. It is also possible for the navigation device 50 to output the position information of the button 2d when receiving the information to notice the change of the main image 2a transferred from the control circuit 20.

In step S103, the main reaction force map 12 (see FIG. 5A and FIG. 5B) stored in the layer 0 is updated on the basis of the position information of the button 2d obtained in step S102, the operation flow returns to step S101. This allows the reaction force supplied from the reaction force supplying part 33 to correctly correspond to the position of the button 2d displayed on the changed main image 2a when the layer 1 and the layer 2 are not activated, namely, ineffective.

Next, a description will be given of the process to update the complementary reaction force map 13 stored in the layer 2 of the interface control part 34 when the complementary image 2d displayed on the complementary display zone 43 is changed with reference to FIG. 8.

The control circuit 20 capable of generating the complementary image 2b outputs the information regarding the change of the complementary image 2b to the local CAN 81 when the operation device 30 receives the zone selection request of the user to change the complementary image 2b displayed on the complementary display zone 43.

In step S201, it is detected whether or not the information to change the complementary image 2b is obtained through the local CAN 81. In step S201, when the detection result indicates positive (affirmation), namely, the information to change the complementary image 2b is received (“YES” in step S101), the operation flow goes to step S202.

On the other hand, when the detection result indicates negative, namely, the information to change the complementary image 2b is not received (“NO” in step S101), the operation flow returns to step S201. The detection in step S201 is executed again.

In step S202, the position information of the button 2e to be displayed on the complementary display zone 43 after the change of the complementary image 2b, namely, the coordinate data of the button 2e transferred from the control circuit 20 through the local CAN 81. The operation flow goes to step 5203. It is possible for the control circuit 20 to output the position information of the button 2e when receiving the request signal transferred from the interface control part 34. It is also possible for the control circuit 20 to output the position information of the button 2e when receiving the information to change the complementary image 2e.

In step S203, the complementary reaction force map 13 (see FIG. 5A and FIG. 5B) stored in layer 2 is updated on the basis of the position information of the button 2e obtained in step S202, the operation flow returns to step S201. This allows the reaction force supplied from the reaction force supplying part 33 to correctly correspond to the position of the button 2d displayed on the changed complementary image 2b when the layer 0 is valid, namely, effective.

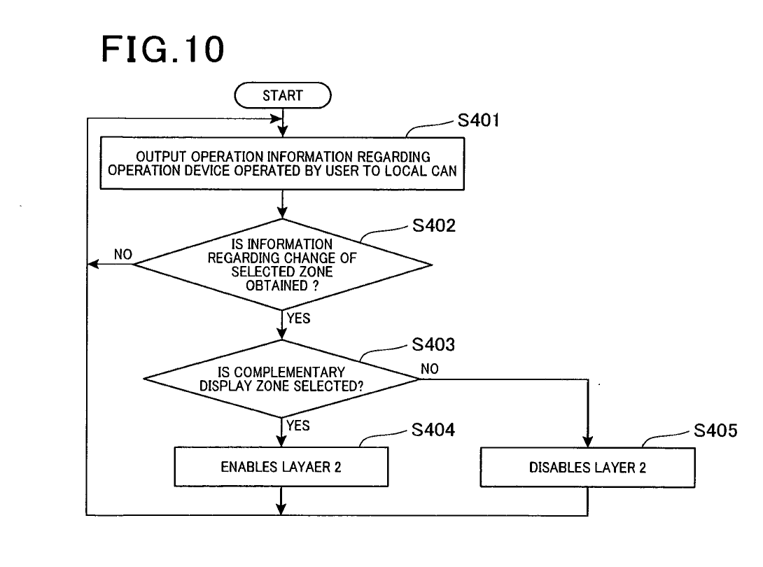

Next, a description will be given of the process to change the selected reaction force map by the interface control part 34 with reference to FIG. 9 and FIG. 10.

FIG. 9 is a flow chart showing a control flow executed by the main control part 21 in the control circuit when receiving a zone selection request for selecting a display zone as a selected display zone from the main display zone and the complementary display zone. FIG. 10 is a flow chart showing a control flow executed by the interface control part 34 in order to select a reaction force map as a selected reaction force map from the main reaction force map and the complementary reaction force map.

In the exemplary embodiment, when the one of the main display zone 42 and the complementary display zone 43 is selected, the corresponding one of the main reaction force map 12 and the complementary reaction force map 13 is selected. The main control part 21 executes the process shown in FIG. 9. On the other hand, the interface control part 34 executes the process shown in FIG. 10.

In step S301, the operation information of the operation lever 31 by the user is obtained from the interface control part 34 through the local CAN 81, the operation flow goes to step S401. The operation information obtained in step 5301 is a coordinate data which shows the deflection position of the operation lever 31 and output to the local CAN 81 in step S401 (which will be explained later). The main control part 21 uses the operation information as the coordinate data to determine the display position of the pointer 2c.

In step S302, the interface control part 34 detects whether or not the current display zone is the main display zone 42. When the detection result in step S302 indicates positive (affirmation), namely, the main display zone 42 is currently selected (“YES” in step S302), the operation flow goes to step S303.

On the other hand, when the detection result in step S302 indicates negative (when the complementary display zone 43 is selected), namely, the main display zone 42 is not currently selected (“NO” in step S302), the operation flow goes to step S305.

In step S303, it is detected whether or not the value of the X coordinate in the coordinate data contained in the operation information obtained in step S301 is not less than 254. When the detection result in step S303 indicates positive (affirmation), namely, that the X coordinate is not less than 254 (“YES” in step S303), the operation flow goes to step S304.

On the other hand, when the detection result in step S303 indicates negative, namely, that the X coordinate is less than 254 (“NO” in step S303), the operation flow returns to step S301, not goes to step S304.

As described above, when the main display zone 42 is selected and the X coordinate value is not less than 254, the pointer 2c is positioned near the boundary part 41a of the main display zone 42. Accordingly, the main control part 21 estimates that the main control part 21 receives the zone selection request to select the complementary display zone 43 as the current display zone from the main display zone 42.

In step S304, the main control part 21 outputs to the local CAN 81 the information regarding the switch from the main display zone 42 to the complementary display zone 43. The operation flow returns to step S301.

In step S305, it is detected whether or not the value of the X coordinate in the coordinate data contained in the operation information obtained in step S301 is not more than 103. When the detection result in step S305 indicates positive (affirmation), namely, that the X coordinate is not more than 103 (“YES” in step S305), the operation flow goes to step S306.

On the other hand, when the detection result in step S305 indicates negative, namely, that the X coordinate is more than 103 (“NO” in step S305), the operation flow returns to step S301, not goes to step S306.

As described above, when the complementary display zone 43 is selected and the X coordinate value is not more than 103, the pointer 2c is positioned near the boundary part 43a of the complementary display zone 43. Accordingly, the main control part 21 estimates that the main control part 21 receives the zone selection request to select the main display zone 42 as the current display zone from the complementary display zone 43.

In step S306, the main control part 2 outputs to the local CAN 81 the information regarding the switch from the complementary display zone 43 to the main display zone 42. The operation flow returns to step S301.

A description will be given of the process shown in FIG. 10.

In step S401, the interface control part 34 outputs the operation information regarding the deflection angle of the operation lever 31 by the user to the local CAN 81. The operation flow goes to step S402. The operation information contains the coordinate data of the operation lever 31 in the operation position coordinate system. As previously explained in step S301, the main control part 21 receives the operation information output on the local CAN 81 in step S401.

In step S402, it is detected whether or not the interface control part 34 obtains the information regarding the change of the selected display zone through the local CAN 81. As previously described, the main control 21 outputs such information to the local CAN 81 in step S304 or step S306.

When the detection result in step S402 indicates positive (affirmation), namely, the interface control part 34 obtains the information through the local CAN 81 (“YES” in step S402), the operation flow goes to step S403.

On the other hand, when the detection result in step S402 indicates negative, namely, the interface control part 34 does not obtain the information through the local CAN 81 (“NO” in step S402), the operation flow returns to step S401.

In step S403, it is detected whether or not the selected display zone is switched to the complementary display zone 43 from the main display zone 42.

When the detection result in step S403 indicates positive (affirmation), namely, the interface control part 34 obtains the information output in step S304, and the selected state is switched to the complementary display zone 43 (“YES” in step S403), the operation flow goes to step S404.

On the other hand, when the detection result in step S403 indicates negative, namely, the interface control part 34 does not obtain the information output in step S306, and the selected state is switched to the main display zone 42 (“NO” in step S403), the operation flow goes to step S405.

In step S404, the interface control part 34 activates the layer 2, and the operation flow then returns to step S401. When the layer 2 is activated (or selected, namely, effective), the operation reaction force to be supplied from the reaction force supplying part 33 to the operation lever 31 is determined on the basis of the complementary reaction force map 13 stored in the layer 2.

In step S405, the interface control part 34 sets layer 2 to an ineffective state. The operation flow returns to step S401. When the layer 2 is in the ineffective state, the reaction force against the operation lever 31 by the reaction force supplying part 33 is determined on the basis of the main reaction force map 12 stored in the layer 0 when the layer 1 is not effective.

In the exemplary embodiment previously described, the main reaction force map 12 corresponding to the main display zone 42 and the complementary reaction force map corresponding to the complementary display zone 43 are stored in advance in the layers of the interface control part 34. Accordingly, when the selected display zone is switched due to the execution of the zone selection request, the interface control part 34 can select the reaction force map corresponding to the selected display zone after the switching process. This makes it possible to promptly and timely supply the reaction force to the operation lever 31 on the basis of the selected reaction force map selected from the reaction force map stored in advance in the interface control part 34. Therefore even if the selected display zone is changed by the user, who inputs the request to move, it is possible to reliably and timely supply the reaction force to the operation lever 31, when the pointer 2c is overlapped with the button 2d or 2e displayed on the selected display zone after the above switching step. The vehicle display device according to the exemplary embodiment provides a superior and comfortable operation to the user.

In addition, when the reaction force map is generated every time the zone selection request transferred from the user is received, like a conventional device, the interface control part 34 must obtain the position information of the button and generate the reaction force map every time the current display zone is changed. Accordingly, a device having the structure to generate the reaction force map every time the zone selection request is received has a possibility of delaying the time to supply the reaction force to the operation lever 31 by the period of time necessary to generate the reaction force map.

On the other hand, as previously described in detail, the interface control part 34 in the vehicle display device 100 according to the exemplary embodiment of the present invention can store in advance the reaction force maps corresponding to display zones, respectively, and which correspond to the position information of each of the buttons 2d and 2e obtained from the navigation device 50 and the control circuit 20. This makes it possible for the reaction force supplying part 33 to promptly supply the reaction force with high accuracy on the basis of the selected reaction force map selected by the interface control part 34. As described above, it is possible for the user such as the vehicle driver to obtain the comfortable operation to the operation lever 31 because the correct reaction force is supplied to the operation lever 31 even if the position information can be obtained from the devices having a different structure and a delay of receiving the position information often occurs.

In addition, the zone selection request to select the display zone as the current display zone can be generated by the user's operation to the operation lever 31, where the user's operation moves the pointer 2c near the boundary part 42a or the boundary part 43a of the selected display zone. Accordingly, it is possible for the user to generate the zone selection request during the request to move the pointer 2c. If the reaction force against the operation of the operation lever 31 is interrupted when the user operates the operation lever 31, the user can recognize the occurrence of such interruption and suffers discomfort operating the operation lever 31.

On the other hand, the reaction force supplying part 33 in the vehicle display device 100 according to the exemplary embodiment can smoothly start to supply the reaction force to the operation lever 31 on the basis of the selected reaction force map selected by the interface control part 34. This makes it possible to certainly avoid the interruption of supplying the reaction force to the operation lever 31. It is possible for the vehicle display device 100 according to the exemplary embodiment to provide comfortable operation of the operation lever 31 even if the above problems occur.

Further, according to the exemplary embodiment, the magnitude of the reaction force against the operation lever 31 has the same so long as the buttons 2d and 2e displayed on the display 40a have the same size when the pointer 2c is overlapped with the button 2d or 2e even if the size of the display zone is different.

Even if the vehicle display device has a structure of switching the reaction force map due to selection of a different display zone, it is possible to have the same reaction force supplied to the operation lever 31 because the buttons 2d and 2e in the reaction force map have a constant resolution. This makes it possible for the vehicle display device to provide comfortable and superior operation to the user such as the driver of the motor vehicle.

Still further, according to the exemplary embodiment, the reaction force supplying part 33 can supply the reaction force opposing the user's inclination of the operation lever 31. This makes it possible for the user to have the correct sense of the reaction force against the user's force to deflect the operation lever 31. As described above, in the vehicle display device having the structure in which the user such as the vehicle driver uses the operation lever 31 and the reaction force against the force to deflect the operation lever 31 is correctly supplied to the user through the operation lever 31, it is possible to suppress the interruption of supplying the reaction force to the operation lever 31, and to provide the comfortable operation to the user.

In particular, the control circuit 20 and the navigation device 50 used in the exemplary embodiment correspond to the image generation means used in the claims. The operation lever 31 corresponds to the input means, the lever part and the joystick used in claims. The interface control part 34 corresponds to the reaction force map storage means and the reaction force map selection means used in the claims. The main display zone 42 corresponds to the first display zone used in the claims. The complementary display zone 43 corresponds to the second display zone used in the claims.

### Other Modifications

The concept of the exemplary embodiment of the present invention is not limited by the example previously described. It is possible to have various modifications and combinations without limiting the scope of the present invention.

In the exemplary embodiment previously described, the main display zone 42 and the complementary display zone 43 are displayed on the display 40a. It is possible to display a plurality of display zones of more than two on the display 40a. When not less than three display zones are displayed on the display 40a, the total number of layers to store the reaction force maps by the interface control part 34 is increased according to the increase of the number of the display zones.

In the exemplary embodiment previously described, the interface control part 34 has a plurality of the layers to store the reaction force map in advance per display zone. Specifically, the layer 0 stores the main reaction force map 12 on the basis of the position information of the button 2d displayed on the main display zone 42, and the layer 2 stores the complementary reaction force map 13 on the basis of the position information of the button 2e displayed on the complementary display zone 43. However, when the device has the structure in which the images formed by a plurality of devices are displayed on the same display zone, it is possible for the interface control part 34 to have a plurality of layers corresponding to the number of a plurality of the devices.

Specifically, in a device where a first main image drawn by a first device and a second main image drawn by a second device are switched and the switched main image is displayed on the main display zone, the interface control part 34 stores in layer 0 the reaction force map which is obtained on the basis of the position information of the button drawn by the first device, and stores into layer 1 the reaction force map which is obtained on the basis of the position information of the button drawn by the second device. The interface control part 34 switches the layer 1 between effective and ineffective states according to the selection of the first main image or the second main image as displayed on the main display zone. This makes it possible for the interface control part 34 to promptly and smoothly start to supply the reaction force to the operation lever 31 even if the image is changed on the same main display zone 42.

In an example having the above structure, the navigation device 50 is used as the first device and a rear-view monitor device is used as the second device. Such a rear view monitor device is equipped with a rear camera placed at a rear side of a motor vehicle, and monitors the rear view of the motor vehicle and outputs the rear view. The rear view monitor device is connected to the local CAN 81, similar to the navigation device 50. In this structure, when the vehicle driver selects the gear lever (or the gear stick) to R (rear) position in the speed gear box in order to move the motor vehicle backwards, the main image displayed on the main display zone is switched from the navigation image 3a transferred from the navigation device 50 to the rear-view image monitored by the rear-view monitor device such as a rear camera.

The interface control part 34 stores the reaction force map into the layer 0 on the basis of the position information of the button on the navigation image 3a and reaction force map into the layer 1 on the basis of the position information of the button which is overlapped with the rear-view image. When the vehicle driver switches the gear lever to R (rear) position in the speed gear box, the layer 1 is switched to the effective state from the ineffective state. As described above, it is possible to smoothly and promptly supply the correct reaction force to the operation lever 31 against the driver's operation in accordance with the switch of the display image on the main display zone 42.

In the above example, the interface control part 34 stores the reaction force map into the layer 2 on the basis of the position information of the button contained in the recognition image stored in the layer 1 (as previously explained). In addition, the interface control part 34 stores the complementary reaction force map into the layer 3 on the basis of the position information of the button 2e displayed on the complementary display zone 43 stored in the layer 2 (as previously described).

In the exemplary embodiment previously described, the zone selection request to select the display zone as the current display zone is transferred to the operation device 30 by the pointer moving request to move the pointer to the boundary parts 42a or 43a of the selected display zone. However, it is possible to transfer the zone selection request to the operation device 31 by touching the switch on the operation device without using the operation lever 31.

Further, it is acceptable to have a structure in which the vehicle driver as the user quickly deflects the operation lever 31 twice toward the direction of the selected display zone displayed on the display in order to generate the zone selection request.

In the exemplary embodiment previously described, the boundary part 42a has an X coordinate within the range of not less than 254 displayed on the main display zone 42, where the selected display zone is switched by using the boundary part 42a. However, the concept of the exemplary embodiment is not limited by this structure. It is possible for the boundary part 42a to have X coordinate within a different range such as a range of not less than 250 or a range of 0 to 255. Similarly, the boundary part 43a has X coordinate within the range of not more than 103 displayed on the complementary display zone 43, where the selected display zone is switched by using the boundary part 43a. However, the concept of the exemplary embodiment is not limited by this structure. It is possible for the boundary part 43a to have X coordinates within a different range other than the range of not more than 103.

In the exemplary embodiment previously described, the complementary reaction force map is formed in X coordinate points within the range of 152 to 255, where the complementary reaction force map corresponds to the complementary display zone 43 which is narrower than the main display zone 42 in order to have the same resolution of the position information of the button 2d in each of the reaction force maps. However, there is a case in which a plurality of buttons 2e such as information image 5b (see FIG. 3) is displayed in a narrow display zone like the complementary display zone 43. In such a case, it is possible to increase the resolution of the complementary reaction force map 13 by using the X coordinate point within the range of 0 to 101 in the layer 2. This structure has a smaller moving distance of the pointer 2c by the user's operation when the pointer 2c is displayed on the complementary display zone 43 when compared with being displayed on the main display zone 42. In other words, this structure makes it possible for the vehicle driver as the user to move the pointer 2c with more high accuracy on the complementary display zone 43. It is thereby possible for the vehicle driver to approach the pointer and select each of the buttons 2c and 2e with high accuracy.

In the exemplary embodiment previously described, the main image 2a displayed on the main display zone 42 is generated with the structure which is different from the structure of the complementary image 2b displayed on the complementary display zone 43.

However, it is possible for each image displayed on each display zone to have the same structure. For example, the image display part 22 in the control circuit 20 generates both the main image 2a and the complementary image 2b. In this structure, the interface control part 34 obtains the position information of the button 2d in the main display zone 42 and the position information of the button 2e in the complementary display zone 43 transferred from the main control part 21 in the control circuit 20. The interface control part 34 then generates the reaction force map in each of the main display zone 42 and the complementary display zone 43 on the basis of the received position information.

In the exemplary embodiment previously described, the operation device 30 is a joystick device equipped with the operation lever 31 as the interface to move the position of the pointer 2c displayed on the display 40a. It is possible to use another input means such as a roller device, instead of such a joystick device, with which the user rotates the roller device in order to move the position of the pointer 2c on the selected display zone.

In the exemplary embodiment previously described, the main image 2a contains the navigation image 3a and the audio image 5a, and the complementary image 2b contains the information image 5b and the fuel consumption image 7b. However the concept of the exemplary embodiment of the present invention is not limited by this so long as it can provide the information to the vehicle driver as the user. For example, when communication devices such as a mobile phone and a portable audio player are connected to the audio device 51, it is possible to display an operation image to operate the communication devices on the main image 2a or the complementary image 2b.

In the exemplary embodiment previously described, the control circuit 20 is comprised of the control microcomputer 25 and the image display microcomputer 26. The control microcomputer 25 is comprised of the main control part 21 as a functional block. The image display microcomputer 26 is comprised of the image display part 22 and the image synthesis part 23 as functional blocks. The concept of the exemplary embodiment of the present invention is not limited by this structure. For example, it is possible for the control circuit 20 to have a single functional block which implements the main control part 21, the image display part 22 and the image synthesis part 23. It is also possible for the control circuit 20 to have the main control part 21, the image display part 22 and the image synthesis part 23 which are analogue circuits without using programs.

In the exemplary embodiment previously described, the navigation device 50 receives the information through the global CAN 80, and the navigation device 50 outputs the information to the local CAN 81, and the control circuit 20 receives the information through the local CAN 81. The concept of the exemplary embodiment of the present invention is not limited by this structure. For example, it is possible for the control circuit 20 to directly receive the information through the global CAN 80 without through the local CAN 81.

In the exemplary embodiment previously described, the LCD device 40 has a structure composed of 1280 dots (display pixels) in lateral direction and 480 dots (display pixels) in vertical direction which are regularly arranged. However, the concept of the exemplary embodiment of the present invention is not limited by this structure. For example, it is possible to use a LCD device composed of dots (display pixels) of either more or less than the above structure. Further, the vehicle display device is equipped with a plasma display device or an organic electro luminescence (organic EL) display device instead of such a LCD device.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A vehicle display device comprising:
a display device equipped with a display mounted to a motor vehicle, a plurality of display zones being displayed on the display, and buttons being displayed on the display zones through which a user inputs operation instruction to control various types of operation regarding the motor vehicle;
an input means through which the user inputs a pointer moving request and a zone selection request, the pointer moving request being an instruction to move a position of a pointer displayed on the display in order to select the buttons, and the zone selection request being an instruction to select a new display zone as a selected display zone from the plurality of the display zones, the user selecting the button displayed on the selected display zone when the user moves the pointer onto the selected display zone;
a reaction force map storage means configured to store a reaction force map which being generated per display zone in advance, the reaction force map determining a reaction force to be supplied to the operation means on the basis of the position information of the button in the selected display zone;
a reaction force map selection means configured to select the reaction force map from a plurality of the reaction force maps so that the selected reaction force map corresponds to the selected display zone when the selected display zone is switched by the zone selection request; and
a reaction force supplying means configured to supply the reaction force to the input means on the basis of the selected reaction force map corresponding to the selected display zone when the pointer is overlapped with the selected display zone, on the basis of the pointer moving request to the pointer, with the button displayed on the selected display zone after completion of the selection of the display zone by the zone selection request.

2. The vehicle display device according to claim 1, further comprising an image generation means configured to generate the buttons per display zone, wherein the buttons are generated on the respective display zone by the corresponding image generation means,
wherein the reaction force supplying means receives the position information of the button displayed on the display zone transferred from the corresponding image generation means, and stores the reaction force map corresponding to the position information of each button for every display zone in advance.

3. The vehicle display device according to claim 1, wherein when the input means inputs the pointer moving request of moving the pointer to a boundary part between the selected display zone and the other display zone which is adjacent to the selected display zone, and the input means inputs the zone selection request to select another display zone as the selected display zone.

4. The vehicle display device according to claim 1, wherein each of the reaction force maps has the same resolution of the position information of each button.

5. The vehicle display device according to claim 1, wherein the input means is a joystick equipped with an operation lever which is deflected by the user, and the reaction force supplying means supplies a reaction force to the operation lever of the joystick in a direction which is opposite to the direction to which the user deflects the operation lever of the joystick.
